(19) United States
(12) Patent Application Publication
(10) Pub. No.: US 2019/0224773 A1
(43) Pub. Date: Jul. 25, 2019

(54) SYSTEM AND METHOD OF JOINING OF DISSIMILAR MATERIALS

(71) Applicant: Optimal Process Technologies, LLC, Plymouth, MI (US)

(72) Inventors: Dan Radomski, Berkley, MI (US); Song Ling Young, Ann Arbor, MI (US); Kyubum Kim, Ann Arbor, MI (US); Tae Hyung Kim, Ann Arbor, MI (US); Shixin Jack Hu, Ann Arbor, MI (US)

(73) Assignee: Optimal Process Technologies, LLC, Ann Arbor, MI (US)

(21) Appl. No.: 15/811,832

(22) Filed: Nov. 14, 2017

Related U.S. Application Data
(60) Provisional application No. 62/421,399, filed on Nov. 14, 2016.

(51) Int. Cl. B23K 11/00

(52) U.S. Cl. CPC B23K 11/0066

(57) ABSTRACT

A process, system and method of joining dissimilar materials. The process utilizes a rivet configured to extend through two layers or dissimilar materials in various configurations. The rivet is inserted using both force and heat generated through resistance heating, specifically one sided spot welding. Preheating may be used to assist with penetration of the rivet into the materials.

The application claims priority and benefit to U.S. provisional application Ser. No. 62/421,399 Filed on Nov. 14, 2016.

### TECHNICAL FIELD

The present specification generally relates to a method, system and apparatus for fastening materials together and, more specifically, a method, system and apparatus for joining dissimilar materials using rivets combined with resistance spot welding.

### BACKGROUND

Various fasteners, apparatus and methods for joining and assembling parts or subunits are known, such as welding, riveting, threaded fasteners, etc. In some instances, there is a need to cost effectively join dissimilar materials. Solutions for these fastening problems include mechanical fasteners in combination with an adhesive. Direct welding between dissimilar materials is not commonly employed due to different melting temperatures of dissimilar material properties between metals when joined together. In cases where direct welding is employed, it is dual sided welding which inhibits welding between tubes or other casted parts or in areas at a center portion of an apparatus.

Furthermore, riveting and bolting such dissimilar materials tends to be undesirable for several reasons. The tensile strength of a rivet joint is relatively low compared to a weld joint. Bolted joints added additional weight to the structure to be joined. Further, extensive and tedious experiments must be conducted to determine the optimal die and rivet for a particular selection of material composition and thickness. Additionally, many riveting and bolting operations are prohibitively complex.

Accordingly, a need exists for alternative process, system and method of joining dissimilar materials.

Thus, it is an object of the present invention to provide a reliable method of joining dissimilar materials. It is a further object of the present invention to provide a method of joining dissimilar materials where the joint is robust and will contribute to the structural integrity of the assembly.

### SUMMARY

The present specification generally discloses a process, system and method of joining dissimilar materials. The process utilizes a rivet configured to extend through two layers or dissimilar materials in various configurations. The rivet is inserted using both force and heat generated through resistance heating, specifically one sided spot welding. Preheating may be used to assist with penetration of the rivet into the materials.

In one embodiment, a system for joining a plurality of parts together is provided where at least two of the parts are composed of dissimilar materials, the system including a base, a joining portion positioned opposite of the base, the joining portion configured to hold and apply force to a rivet, the joining portion configured to apply a force to the rivet so as to insert the rivet at least partially through at least the two parts and the joining portion configured to simultaneously heat the rivet so as to weld the parts together wherein by means of simultaneous force application and welding, any weld nugget is formed within the rivet thereby inhibiting oxidation and/or corrosion by encapsulating any weld nugget created by welding. In some embodiments, the rivet has a generally hollow midsection wherein the weld nugget is formed where the rivet is generally cylindrical having a generally flat top portion. In some embodiments, the welding process is one sided spot welding. In other embodiments, the area to be joined is preheated prior to welding to facilitate easier insertion of the rivet into the parts.

In some embodiments, the system is automated providing for automatic insertion of the rivet and subsequent welding. In these embodiments, a rivet holding strip is utilized to facilitate automation of the system.

A method of using the system of claim 1 wherein the system further includes at least one sensor configured to monitor the status of the weld nugget, the method comprising the steps of monitoring the sensor for data, estimating the progress of the present weld condition based on the data received from the sensor and adjusting the weld properties based on the estimate of the progress of the present weld so as to adjust time to completion and/or quality of the present weld. The sensor may be a force sensor, a current sensor, a voltage sensor, a temperature sensor and/or a displacement sensor. The data measured includes the size of the present weld nugget and/or the quality of the weld. The weld properties include the current applied to the parts to weld the parts together and/or the force applied to the rivet so as to weld the parts together. Data from a cloud based data set may also be used to determine the status of the weld.

### BRIEF DESCRIPTION OF THE DRAWINGS

The embodiments set forth in the drawings are illustrative and exemplary in nature and not intended to limit the subject matter defined by the claims. The following detailed description of the illustrative embodiments can be understood when read in conjunction with the following drawings, where like structure is indicated with like reference numerals and in which:

FIG. 1 depicts a perspective view of an exemplary joint manufacturing apparatus according to one or more embodiments shown and described herein;

FIG. 2 depicts a close up frontal and partial cross-sectional view of an exemplary joint manufacturing apparatus according to one or more embodiments shown and described herein;

FIG. 3 depicts a perspective view of a rivet according to one or more embodiments shown and described herein;

FIG. 4A depicts a rivet position at initial contact to the aluminum at an exemplary method of the joint manufacturing of the present process according to one or more embodiments shown and described herein;

FIG. 4B depicts an exemplary rivet starting penetration with preheating at an exemplary method of the joint manufacturing of the present process according to one or more embodiments shown and described herein;

FIG. 4C depicts an exemplary rivet where contact with the bottom sheet has started at an exemplary method of the joint manufacturing of the present process according to one or more embodiments shown and described herein;

FIG. 4D depicts a start of the fusion weld at an exemplary method of the joint manufacturing of the present process according to one or more embodiments shown and described herein;

FIG. 4E depicts the nugget growth within the encapsulated rivet at an exemplary method of the joint manufacturing of the present process according to one or more embodiments shown and described herein;

FIG. 4F depicts the finished weld fully encapsulated within the rivet at an exemplary method of the joint manufacturing of the present process according to one or more embodiments shown and described herein;

FIG. 5 depicts an exemplary cross-sectional view the joint according to one or more embodiments shown and described herein;

FIG. 6A illustrates an exemplary cross sectional perspective view of a sheet to sheet joint of dissimilar materials according to one or more embodiments shown and described herein;

FIG. 6B illustrates an exemplary cross perspective view of the sheet to sheet joint of FIG. 6A of dissimilar materials according to one or more embodiments shown and described herein;

FIG. 6C illustrates an exemplary cross sectional perspective view of joining a sheet to a tube of dissimilar materials according to one or more embodiments shown and described herein;

FIG. 6D illustrates a perspective view of the embodiment as shown in FIG. 8C according to one or more embodiments shown and described herein;

FIG. 6E illustrates a perspective cross section view of a sheet jointed to a cased part of dissimilar materials according to one or more embodiments shown and described herein;

FIG. 6F illustrates the embodiment as shown in FIG. 8E according to one or more embodiments shown and described herein;

FIG. 7 illustrates a graphical representation of the testing data illustrating a joint being tested according to one or more embodiments shown and described herein;

FIG. 8 illustrates an exemplary embodiment of combined components to create the present system illustrates a joint being tested according to one or more embodiments shown and described herein; and

FIG. 9 illustrates a flow chart depicting the process and method of the present system described herein according to one or more embodiments shown and described herein.

### DETAILED DESCRIPTION

The drawings of the present specification generally depict one embodiment of a process, system and method of joining dissimilar materials. The process utilizes a rivet configured to extend through two layers or dissimilar materials in various configurations. The rivet is inserted using both force and heat generated through resistance heating, specifically one sided spot welding. Preheating may be used to assist with penetration of the rivet into the materials.

As both force and current are applied to the rivet, a nugget within the rivet forms to strengthen the joint. The weld (strength, intensity . . . etc.) may be controlled by the current applied to the rivet. Any weakness (i.e. the weld nugget) is fully contained and encapsulated within the rivet. Furthermore, encapsulation of the nugget and weld joint inhibits oxygen and/or water from reaching the weld thereby preventing any oxidation and/or corrosion.

The present process may be used in automotive or other transportation applications, construction, consumer goods and any other industry seeking to lightweight their structures and benefit from the joining of dissimilar materials. Particularly, industry applications where weight is a factor in production. Decreased weight in vehicles and other transportation yields decreased fuel used. Government and environmental demands dictate that vehicles must be lighter. If a lighter weight material may be joined with an existing material (required for increased strength) where a heavier material was previously used, the present specification becomes particularly advantageous (i.e. joining aluminum to steel where only steel was previously used, but was very heavy). Exemplary application of joining dissimilar materials include automotive (particularly body in white applications, roof enclosure systems, pillar connections, sheet panel connections . . . etc.), marine, RV, aircraft, consumer products, batteries and any other suitable application where joining of dissimilar materials would be advantageous.

Referring now to FIG. 1, an apparatus 100 for joining dissimilar materials is disclosed. The apparatus 100 includes a base 102 and a joining portion 104. The joining portion 104 is configured to insert a rivet and/or apply force to the rivet to join the materials. The joining portion 104 is also configured to supply a current thereby controlling the weld.

A rivet holding strip 106 is configured to hold a plurality of rivets for insertion to connect dissimilar materials. The rivet holding strip is held by a holding portion 108 connected to the overall apparatus 100. The holding strip 106 includes end portions 110 which are fed through the joining portion 104. The rivet holding strip 106 may also be incorporated into an automated system providing for automatic insertion of the rivet and subsequent welding.

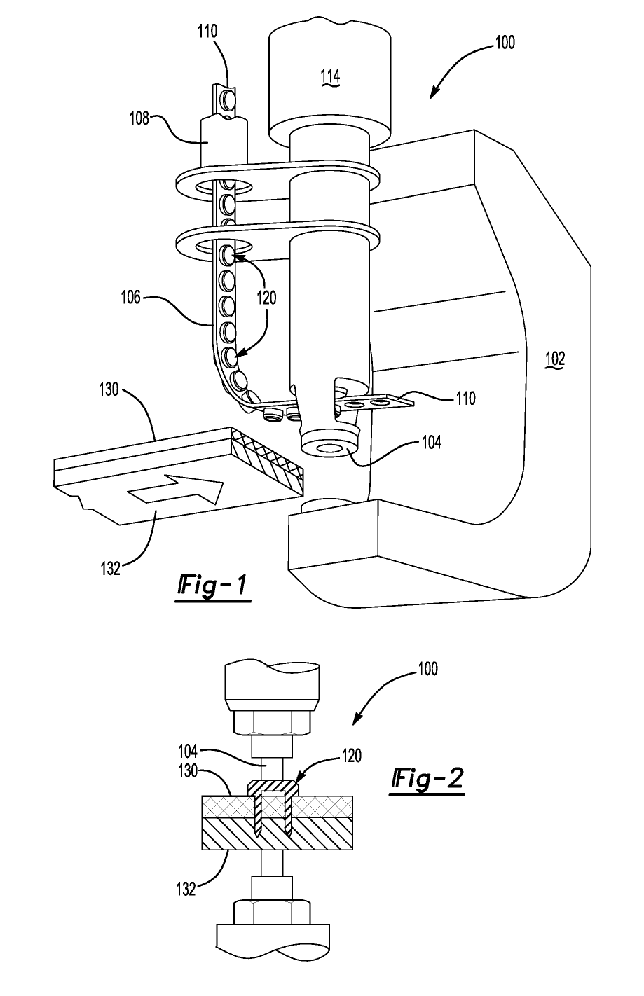

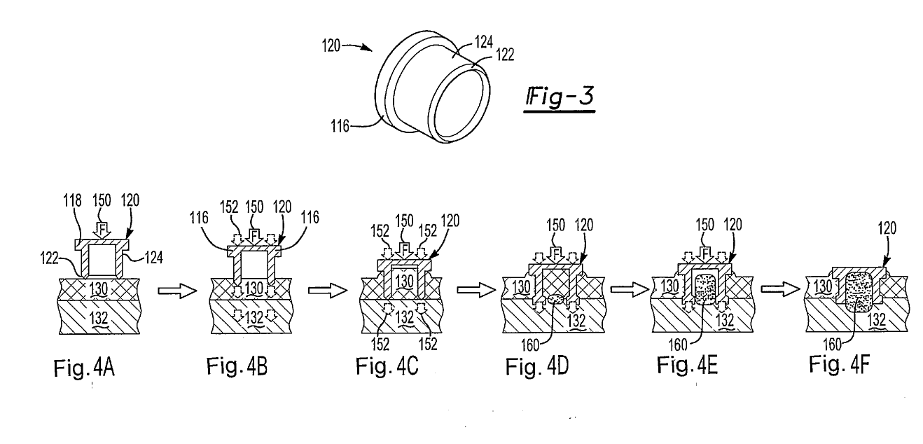

FIG. 2 generally depicts a photographic view of the apparatus 100 as shown in FIG. 1. The apparatus of FIG. 2 includes a one-sided electrode and a shunt electrode where a sheet is being connected to a high strength steel rectangular tube. Current is applied to the electrode and may be controlled to control the weld.

FIGS. 1 and 2 is an exemplary embodiment showing the apparatus 100 having the joining portion 104. The joining portion 104 generally includes an electrode and a force supplying means. The joining portion 104 may also be referred to as the weld gun. In some embodiments, the weld gun is customized to meet the present specifications. The system may be designed with a custom indirect weld gun to enable one-sided welding due to the low weld current and force associated with the process. The apparatus 100 includes a computer and current controller connected to the apparatus 100. The apparatus, may be used in an automated one-sided joining process, such as discussed above, thereby expediting the joining of dissimilar materials using the present apparatus and method. The apparatus may be a synchronized riveting and welding production process as opposed to a sequential manufacturing step process.

FIGS. 4A-4F illustrates an exemplary cross-sectional view of a joint between dissimilar materials using the present apparatus 100. A rivet 120 is shown having an upper portion 118 and a lower portion 122. As shown in the cross-sectional view of FIG. 4, the lower portion 122 creates a space between walls 124. The rivet 120 is configured to penetrate the first layer of aluminum 130 and partially into the second layer of high strength steel 132. The rivet 120 is fully inserted into the first layer of aluminum 130. Insertion of the rivet 120 is provided upon an exertion of external force 150. As the force 150 is applied, a current 152 is simultaneously applied to create a weld 160 between the aluminum 130 and the high strength steel 132. In some embodiments, the rivet 120 is hollow. In other embodiments, the rivet is a solid cylindrical shank. In even further embodiments, the rivet includes a hollow portion or cutout of the shank so as to facilitate the welding process. The methods disclosed herein may be applied to any of the rivet configurations. In one embodiment as disclosed above, the rivet 120 may be hollow and include extended side portions 116 extending over the lower portion 122. The current shunt allows the current to pass around the weld 160 by creating a low resistance path to assist in the welding.

FIG. 4 illustrates the process of inserting the rivet 120 by applying the force 150 and a current 152. FIG. 4A depicts the rivet 120 above the aluminum 130 and prior to insertion into the aluminum 130.

FIG. 4B illustrates starting of the rivet 120 penetrating through the aluminum 130 with preheating. As shown in this embodiment, the rivet may be heated to assist in insertion into the layers of material. Heating may be done by an external heat source or through the application of high current to the rivet. The rivet may be hollow in shape to avoid punching out or removal of material in the joining process.

FIG. 4C illustrates the rivet 120 penetrated fully through the aluminum 130 and making contact with the steel sheet 132. The rivet just barely starts to contact the steel sheet and the weld fusion begins to start.

FIG. 4D illustrates fusion of the weld start where the rivet 120 is fully penetrated through the aluminum 130 and a weld 160 is starting to form. The riveting and welding perform simultaneously in one manufacturing process step. The weld nugget is essentially a small pool of molten metal that cools and then solidifies into a round joint known as a nugget. Spot welding, the welding process used in the present disclosure, is a process in which contacting metal surfaces are joined by the heat obtained from resistance to electric current. This heat melts the metal to form the “nugget” and the joint is formed. In the present disclosure, the spot welding is one sided with no limit to the depth of the bottom material being joined thereby allowing the joining of several configurations of materials, not merely sheet to sheet, but also sheet to tube and sheet to casting/forging, as examples. The rivet 120 may be custom designed to ensure a flush flat surface with the upper material to comply with industry application requirements.

FIG. 4E illustrates growth of the weld nugget 160 as force and current 150, 152 are being applied.

Finally, FIG. 4F illustrates the weld finish where the weld nugget 160 is fully formed and the aluminum 130 is fully connected with the steel 132. The present disclosure is particularity advantageous in that the weld nugget is fully encapsulated within the rivet. Any weakness (i.e. the weld nugget) is fully contained and encapsulated within the rivet. Furthermore, encapsulation of the nugget and weld joint inhibits oxygen and/or water from reaching the weld thereby preventing any oxidation and/or corrosion.

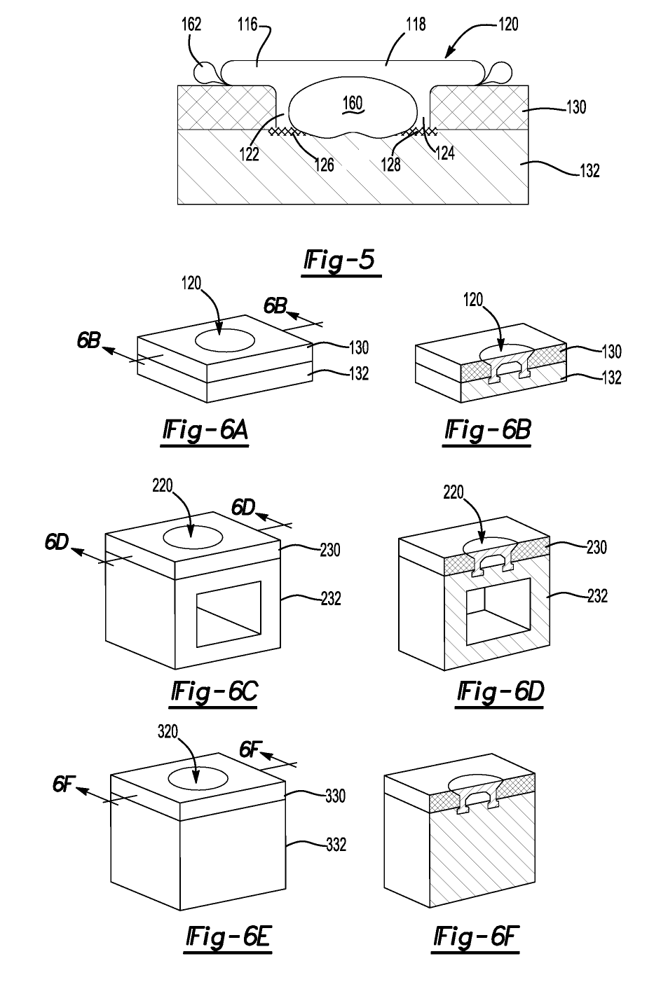

FIG. 5 illustrates an embodiment of the rivet 120 having an upper portion 118 with extended side portions 116 and a lower portion 122. In this embodiment, a splatter 162 made be formed at the side portions 116 of the rivet 120. In this embodiment, a weld nugget 160 is also formed and fully encapsulated within the rivet 120 between the upper portion 118 of the rivet and the steel 132. The rivet shape 116 may be custom designed to ensure a flush flat surface with the upper material to comply with industry application requirements.

FIGS. 6A and 6B are exemplary embodiments, such as hereinafter described, where a rivet 120 is used to connect aluminum 130 to steel 132, both in sheet form. A cross-sectional illustration is provided at FIG. 8A and a photographic example of connection between aluminum 130 and steel 132 is illustrated in FIG. 8B.

FIGS. 6C and 6D illustrate an exemplary embodiment of connecting a sheet to a tube where the sheet and tube are of dissimilar materials. A rivet 220 is used to connect a sheet 230 to a tube 232. A one-sided electrode and/or welding permits force and current to be applied to the rivet 220 thereby enabling connection between a sheet 230 and a tube 232. FIG. 8C illustrates a drawing view of connection of the sheet 230 to the tube 232 whereas FIG. 8D illustrates a photographic example of the rivet 220 connecting the sheet 230 the tube 232.

FIGS. 6E and 6F illustrate an exemplary embodiment of a rivet connecting a sheet to a casted part. In the embodiment as illustrated in FIG. 8E, a rivet 320 is used to connect a sheet 330 to a casted part 332. FIG. 8F illustrates a photographic view of the illustration as illustrated in 8E where a rivet 320 is used to connect a sheet 330 to a casted part 332. In this embodiment where a sheet is connected to a casted part 332, the rivet extends only into a portion of the casted part 332 and not fully though the casted part. The rivet is designed to allow of connection of a sheet (or other structure) to a second part with no limit in depth and/or thickness.

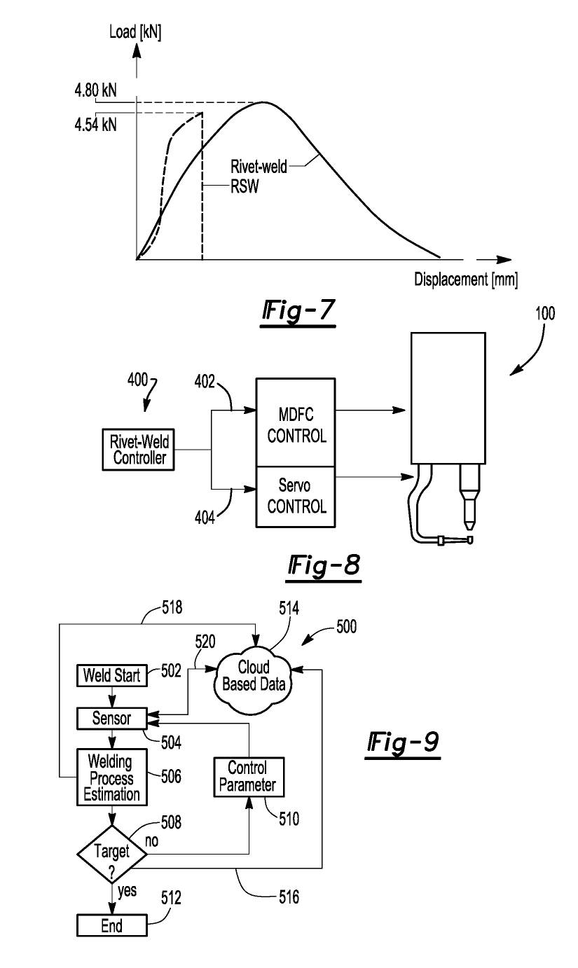

FIG. 7 generally depicts testing data and testing samples using the process described herein to connect aluminum to steel using a rivet inserted by force and using current to control the weld.

FIG. 8 generally depicts the rivet weld controller connected to the apparatus 100. The rivet weld controller 400 includes an MFDC control 402 and servo control 404. The MFDC control 402 is configured to control the welding current thereby controlling the weld and weld nugget created within the rivet 120, 220, 320. The servo control 404 is used to control the welding force as applied to the rivet 120, 220, 320.

FIG. 9 generally depicts a flow chart illustrating the steps taken during the rivet insertion process using both force and current. The method 500 generally includes the steps of Starting 502 the weld and rivet insertion, such as described by the structure above. As the process starts, at least one Sensor(s) 504 is(are) monitored for data. The data received from the Sensor(s) 504 is used to simulate and/or estimate the current weld in process. If the data shows that the weld is on target to complete the weld, then the process stops. If the data indicates that the weld is not on target, then the system will proceed to change Control Parameters 510 (such as the force and/or current) to adjust. Data is continuously taken from the Sensor(s) 504 and evaluated in the Weld Process Estimator 506 until the weld is complete at the End 512.

The Start 502 is characterized in that the beginning of the weld process is initiated. Both current and force are applied to the rivet so as to facilitate the welding between the dissimilar materials.

The Sensor(s) 504 may include a force sensor, a current sensor, a voltage sensor, a temperature sensor, a displacement sensor/encoder. The force sensor may be tied to a force applicator which actuates by means of air pressure and/or electric motor. The sensors produce date which is connected by an electronic control unit for processing by the Weld Process Estimator 506.

The Weld Process Estimator 506 includes processing of the data received from the Sensor(s) 504 described above to simulate the current weld actually occurring. The data from the Sensor(s) 504 is inputted into the Welds Process Estimator 506 to simulate and estimate the size and quality of weld so that the Control Parameter(s) 510 may be adjusted if necessary to produce a quality and timely weld. The Weld Process Estimation 506 portion produces a simulation of the weld. The simulation is an imitation of the weld of a real-world process or system over time. The act of simulating the weld first requires that a model be developed; this model represents the key characteristics or behaviors/functions of the selected physical or abstract system or process. The model represents the system itself, whereas the simulation represents the operation of the system over time. Once quality of the weld is estimated, then the weld itself can physically be controlled.

The Target 508 may be the weld size, temperature and/or displacement of the rivet. If the Target 508 is met, then the process Ends 512. If the Target 508 is not met, a Control Parameter 510 may be adjusted.

The Control Parameter(s) 510 may include the current applied to the weld site and/or the force applied. Data is continuously taken from the Sensor(s) 504 and evaluated in the Weld Process Estimator 506 until the weld is complete at the End 512.

A Cloud Database 514 may be utilized to store data received from the Sensor(s) 504. The Cloud Database may also store data relating to if a target was reached (as illustrated by line 516). Additionally and/or alternatively, the Cloud Database 514 may include past data stored from the present apparatus or from a 3rd party apparatus and/or system. In one embodiment, data from at least one system is uploaded to the Cloud Database 514. The system and Welding Process Estimator 506 can use data from the Cloud Database 514 to estimate the weld. In yet another embodiment, data from both the Sensor(s) 504 and the Cloud Database 514 is used in the Weld Process Estimation 506.

Data may be exchanged, updated and otherwise shared between the Sensor 504 and the Cloud Database 514 (as illustrated by line 520). Further, data and results from the Weld Process Estimation 506 may also be transferred to the Cloud Database 514.

Over time, weld quality is learned and there will be less of a need to continuously take data from the Sensor(s) 504 as the system gathers additional data from the present system and from 3rd party systems who store data on the Cloud Database 514.

It is noted that the terms “substantially” and “about” may be utilized herein to represent the inherent degree of uncertainty that may be attributed to any quantitative comparison, value, measurement, or other representation. These terms are also utilized herein to represent the degree by which a quantitative representation may vary from a stated reference without resulting in a change in the basic function of the subject matter at issue.

While particular embodiments have been illustrated and described herein, it should be understood that various other changes and modifications may be made without departing from the spirit and scope of the claimed subject matter. Moreover, although various aspects of the claimed subject matter have been described herein, such aspects need not be utilized in combination. It is therefore intended that the appended claims cover all such changes and modifications that are within the scope of the claimed subject matter.

What is claimed is:

1. A system for joining a plurality of parts together where at least two of the parts are composes of dissimilar materials, the system comprising:
a base;
a joining portion positioned opposite of the base, the joining portion configured to hold and apply force to a rivet;
the joining portion configured to apply a force to the rivet so as to insert the rivet at least partially through the at least two parts; and
the joining portion configured to simultaneously heat the rivet so as to weld the parts together;
wherein by means of simultaneous force application and welding, any weld nugget is formed within the rivet thereby inhibiting oxidation and/or corrosion by encapsulating any weld nugget created by welding.

2. The system of claim 1 wherein the rivet has a generally hollow midsection wherein the weld nugget is formed.

3. The system of claim 1 wherein the rivet is generally cylindrical having a generally flat top portion.

4. The system of claim 1 wherein the welding process is one sided spot welding.

5. The system of claim 1 wherein the area to be joined is preheated prior to welding to facilitate insertion of the rivet into the parts.

6. The system of claim 1 wherein the system is automated providing for automatic insertion of the rivet and subsequent welding.

7. The system of claim 6 wherein a rivet holding strip is utilized to facilitate automation of the system.

8. A method of using the system of claim 1 wherein the system further includes at least one sensor configured to monitor the status of the weld nugget, the method comprising the steps of:
monitoring the sensor for data;
estimating the progress of the present weld condition based on the data received from the sensor;
adjusting the weld properties based on the estimate of the progress of the present weld so as to adjust time to completion and/or quality of the present weld.

9. The method of claim 8 wherein the sensor is a force sensor.

10. The method of claim 8 wherein the sensor is a current sensor.

11. The method of claim 8 wherein the sensor is a voltage sensor.

12. The method of claim 8 wherein the sensor is a temperature sensor.

13. The method of claim 8 wherein the sensor is a displacement sensor.

14. The method of claim 8 wherein the data measured includes the size of the present weld nugget.

15. The method of claim 8 wherein the data measured includes the quality of the present weld nugget.

16. The method of claim 8 wherein the weld properties include the current applied to the parts to weld the parts together.

17. The method of claim 8 wherein the weld properties include the force applied to the rivet so as to weld the parts together.
